(19) United States
(12) Patent Application Publication
(10) Pub. No.: US 2022/0388626 A1
(43) Pub. Date: Dec. 8, 2022

(54) AIRCRAFT COMPRISING A HOLD FITTED WITH A DEVICE FOR LOADING AND UNLOADING CONTAINERS

(71) Applicant: Airbus SAS, BLAGNAC (FR)

(72) Inventor: Diego ALONSO TABARES, BLAGNAC (FR)

(21) Appl. No.: 17/831,866

(22) Filed: Jun. 3, 2022

(30) Foreign Application Priority Data
Jun. 7, 2021 (FR) 2105943

(51) Int. Cl. B64C 1/22

(52) U.S. Cl. CPC B64C 1/22

(57) ABSTRACT

An aircraft including at least one hold configured to store containers along at least one storage line, and at least one opening configured to provide a passage between the hold and the exterior of the aircraft, the opening being positioned in vertical alignment with the storage line or in line with the storage line. The hold comprises at least one loading and unloading device comprising at least one carriage, at least one guiding system configured to move the carriage along the storage line, at least one spreader equipped with at least one system for grasping the containers, and at least one vertical movement system that is configured to move the spreader vertically with respect to the carriage.

### CROSS-REFERENCES TO RELATED APPLICATIONS

This application claims the benefit of the French patent application No. 2105943 filed on Jun. 7, 2021, the entire disclosures of which are incorporated herein by way of reference.

### FIELD OF THE INVENTION

The present application relates to an aircraft comprising a hold that is fitted with a device for loading and unloading containers.

### BACKGROUND OF THE INVENTION

According to one embodiment, an aircraft fuselage comprises, in its lower portion, a hold and at least one lateral hold door that serves as a passage between the hold and the exterior of the fuselage. The hold is configured to contain a plurality of containers positioned one behind the other along a storage line. The hold comprises a floor, rolling mechanisms that make it easier for the containers to slide over the floor, and nets or stowable stops in order to immobilize the containers once they are correctly positioned.

Prior to being loaded, the containers are positioned on dollies towed by a tractor to the foot of the aircraft. Each dolly is generally provided with a pivoting plate in order to change the orientation of the container borne by the dolly. An item of airport transfer equipment such as an elevator or an inclined belt is required in order to move each container from the dolly to the lateral hold the door.

When loading the containers in the hold, a first operator, stationed on the ground, moves each container from a dolly to the airport transfer equipment and, if necessary, into the correct orientation. A second operator controls the airport transfer equipment and, possibly, a semi-automatic loading system. In the absence of a loading system of this kind, other operators stationed in the hold push each container from the lateral hold door to its final station, and immobilize it.

When unloading, operators stationed in the hold push each container to the airport transfer equipment while another operator, stationed on the ground, pushes each container of the airport transfer equipment to a dolly.

This loading/unloading approach is not satisfactory as the operations of handling the containers are time-consuming and may be difficult to automate.

The present invention seeks to remedy all or some of the drawbacks of the prior art.

### SUMMARY OF THE INVENTION

To that end, the invention relates to an aircraft comprising a fuselage, at least one hold positioned in the fuselage and configured to store containers along at least one storage line, and at least one opening configured to provide a passage between the hold and the exterior of the fuselage, wherein the opening is positioned in vertical alignment with the storage line or in line with the storage line, and wherein the hold comprises at least one loading and unloading device comprising at least one carriage, at least one guiding system configured to move the carriage along the storage line, at least one spreader equipped with at least one grasping system and at least one vertical movement system that is configured to move the spreader vertically with respect to the carriage, the grasping system being configured to adopt an activated state in which the grasping system secures the spreader to a container and a deactivated state in which the spreader is separated from the container. In addition, the hold comprises a lower wall on which the containers are positioned, multiple stations positioned along the storage line, one for each container, and at least one immobilizing system for each station, this being configured to adopt an activated state in which the immobilizing system immobilizes a container with respect to the hold and a deactivated state in which the immobilizing system allows the container to move.

Due to the loading and unloading device, it is no longer necessary to provide airport equipment for transferring the containers between the ground and hold. Moreover, the loading and unloading device makes it possible to dispense with the time-consuming tasks for the operators.

According to one feature, the opening is positioned in the lower portion of the fuselage.

According to another feature, the hold comprises an upper wall, and wherein the guiding system comprises at least one rail that is secured to the upper wall of the hold, along the storage line and extending between a first end allowing the carriage to grasp a container located outside the fuselage and a second end allowing the carriage to be positioned in vertical alignment with a station, for a container, that is furthest from the opening.

According to another feature, the vertical movement system comprises at least one winch that is secured to a first element among the carriage and the spreader, and at least one cable connecting the winch to a second element, different from the first element, among the carriage and the spreader.

According to another feature, the grasping system comprises at least one hook that is able to move between an attached position in which it engages with a container, allowing the spreader to support the container, and a detached position in which the hook does not engage with the container, the grasping system comprising, for each hook, a recess in the container that is configured to receive the hook when it is in the attached position.

According to another feature, the grasping system comprises two first hooks that are configured to engage with first recesses located on a first face of the container and second hooks that are configured to engage with second recesses located on a second face, opposite the first face, of the container.

According to another feature, each container comprises a container identifier and/or each station comprises a station identifier. In addition, the loading and unloading device comprises at least one piece of detection equipment among at least a reader configured to detect the station and/or container identifiers and at least one control system that serves to determine an activated or deactivated state of the grasping system and/or of the immobilizing system of each station.

According to another feature, the loading and unloading device comprises a control system that is configured to control at least one element among the grasping system, the vertical movement system, the carriage and the immobilizing systems of the various stations.

According to another feature, the loading or unloading device comprises a communication system that is configured to remotely control the control system and/or at least one computer program that is configured to control the control system.

### BRIEF DESCRIPTION OF THE DRAWINGS

Other features and advantages will emerge from the following description of the invention, which description is given solely by way of example, with reference to the appended drawings in which:

FIG. 1 is a schematic depiction of an aircraft illustrating an embodiment of the invention,

FIG. 2 is a cross section through an aircraft fuselage, illustrating an embodiment of the invention,

FIG. 3 is a schematic representation of a container immobilizing system in the deactivated state, illustrating an embodiment of the invention,

FIG. 4 is a schematic representation of a container immobilizing system, shown in FIG. 3, in the activated state,

FIG. 5 is a schematic top view of part of an aircraft hold fitted with a device for loading and unloading containers, illustrating an embodiment of the invention,

FIG. 6 is a schematic side view of an aircraft hold fitted with a device for loading and unloading containers, during a step of grasping a container,

FIG. 7 is a schematic side view of the hold shown in FIG. 6, when a container enters the hold,

FIG. 8 is a schematic side view of the hold shown in FIG. 6, when a container is moved in the hold, and

FIG. 9 is a schematic side view of a loading and unloading device, illustrating an embodiment of the invention.

### DETAILED DESCRIPTION OF THE PREFERRED EMBODIMENTS

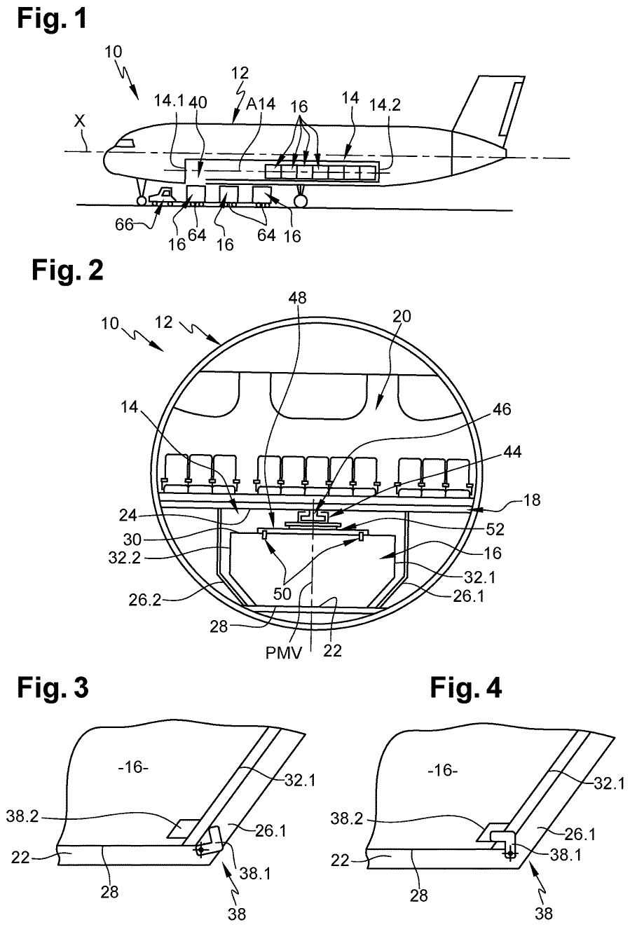

According to one embodiment, shown in FIGS. 1 and 2, an aircraft 10 comprises an approximately cylindrical fuselage 12 which has a longitudinal axis X. Of course, the invention is not limited to this aircraft shape. Thus, the aircraft could be triangular when seen from above.

The fuselage 12 comprises, in its lower portion, at least one hold 14 that is configured to contain containers 16 positioned one after the other along at least one storage line A14 between front and rear ends 14.1, 14.2 of the hold 14. In the case of an aircraft 10 that is cylindrical in shape, the hold 14 comprises a storage line A14 that coincides with the longitudinal direction X of the fuselage 12. According to another configuration, the hold 14 comprises multiple storage lines A14 that are straight and mutually parallel.

Whatever the embodiment, the aircraft 10 comprises at least one hold 14 which has at least one storage line A14.

According to one configuration, the fuselage 12 comprises a floor 18 that separates the hold 14 that is positioned below the floor 18 and a passenger cabin 20 that is positioned above the floor 18.

The hold 14 comprises a lower wall 22 on which the containers 16 are positioned, an upper wall 24 that is substantially parallel to the lower wall 22, and left and right walls 26.1, 26.2. When the aircraft 10 is on the ground, the lower and upper walls 22, 24 are substantially horizontal.

When stored in the hold 14, the containers 16 rest on the lower wall 22 of the hold 14.

According to one embodiment, each container 16 has a lower face 28, an upper face 30, right and left faces 32.1, 32.2, and front and rear faces 34.1, 34.2. When a container 16 is positioned in the hold 14, its front and rear faces 34.1, 34.2 are positioned in planes perpendicular to the storage line A14, and the right and left faces 32.1, 32.2 are respectively oriented towards the right and left walls 26.1, 26.2 of the hold 14.

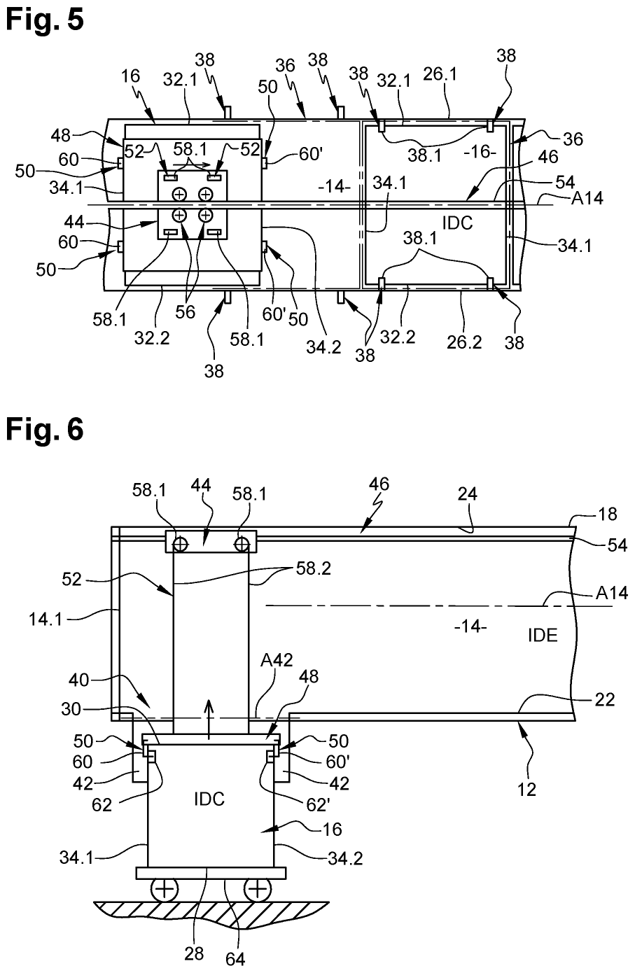

According to one configuration, shown in FIGS. 5 to 9, the various faces 28, 30, 32.1, 32.2, 34.1, 34.2 are planar and the container 16 is parallelepipedal. In this case, the right and left walls 26.1, 26.2 of the hold 14 are planar and vertical. According to another configuration, shown in FIGS. 2 to 4, the lower, upper, front and rear faces 28, 30, 34.1, 34.2 are planar and the right and left faces 32.1, 32.2 each comprise an upper panel that is perpendicular to the upper face 30 and a lower panel that is inclined so that the lower face 28 is smaller than the upper face 30. In this case, the right and left walls 26.1, 26.2 of the hold 14 each also have an upper panel that is perpendicular to the upper wall 24 and a lower panel that is inclined in the same way as the right and left faces 32.1, 32.2 of the container 16.

According to one embodiment, each container 16 has a shape that is approximately symmetric with respect to a vertical median plane PMV.

The container 16 are all identical and all have the same cross section (section considered in a vertical plane perpendicular to the vertical median plane PMV), and the same width (distance between the front of their faces).

According to one configuration, the hold 14 has right and left walls 26.1, 26.2 that are slightly spaced apart from the right and left faces 32.1, 32.2 of the containers 16 when the latter are positioned in the hold 14 along the storage line A14.

The hold 14 comprises multiple stations 36 (shown in FIG. 5) located along the storage line A14, one each container 16. Since the containers 16 all have the same width, the stations 36 are at regular intervals along the storage line A14, between the front and rear ends 14.1, 14.2 of the hold 14. At each station 36, the container 16 rests on the lower wall 22 of the hold 14.

According to one embodiment, each station 36 comprises a station identifier IDE, such as a marking on the lower wall 22 and/or at least one of the right and left walls 26.1, 26.2 of the hold 14.

Each station 36, the hold 14 comprises a system for centering each container 16 with respect to the station 36 that it is in. By way of example, the lower wall 22 of the hold 14 comprises, for each station 36, at least one centering peg that is configured to be received in a recess provided on the lower face 28 each container 16.

According to one embodiment, the hold 14 comprises, for each station 36, an immobilizing system 38 that is configured to adopt an activated state in which the immobilizing system 38 immobilizes the container 16 with respect to the hold 14, and a deactivated state in which the immobilizing system 38 allows the container 16 to move. Each immobilizing system 38 serves for connecting a container 16 to the lower wall 22 of the hold 14.

According to one configuration, shown in FIGS. 3 to 5, each immobilizing system 38 comprises at least one lock 38.1 that is secured to the hold 14 and is able to move between an unlocked position, corresponding to the deactivated state as shown in FIG. 3, and a locked position, corresponding to the activated state shown in FIG. 4. In addition, each immobilizing system 38 comprises, for each lock 38.1, a recess 38.2 that is positioned on each container 16 and is configured to accommodate the lock 38.1 when the container 16 is positioned at the station 36 and the lock 38.1 is in the locked position.

According to one configuration, shown in FIGS. 3 and 4, the locks 38.1 are positioned at the lower wall 22 or at regions where the lower wall 22 meets the right and left walls 26.1, 26.2. When they are in the unlocked position, the locks 38.1 do not stand proud of the lower wall 22 or the right or left wall 26.1, 26.2.

According to one configuration, shown in FIG. 5, each station 36 comprises four locks 38.1 and each container 16 comprises four recesses 38.2, first and second recesses 38.2 positioned on the right face 32.1, close to the lower face 28, one being close to the front face 34.1 and the other close to the rear face 34.2, third and fourth recesses 38.2 positioned on the left face 32.2, close to the lower face 28, one being close to the front face 34.1 the other close to the rear face 34.2. The four locks 38.1 of a station 36 are positioned so that they can be placed facing the recesses 38.2 of a container 16 positioned on the station 36.

According to one embodiment, the immobilizing systems 38 operate automatically and autonomously. According to this embodiment, the hold 14 comprises at least one locking/unlocking actuator that is configured to position each lock 38.1 of each station 36 in the locked position or in the unlocked position.

Of course, the invention is not restricted to the above-described embodiments for the immobilizing systems 38. The hold 14 may also be designed to store objects loose (that is to say, not in containers). In this case, nets may be installed in order to immobilize the loose objects in the hold 14.

The fuselage 12 comprises at least one opening 40 that is configured to provide a passage between the hold 14 and the exterior of the fuselage 12.

According to one embodiment, the opening 40 is positioned in the lower portion of the fuselage 12 and is configured to make it possible to insert each container 16 into the hold 14 by vertical translation. This opening 40 has a cross section that is slightly greater than the maximum horizontal cross section of the containers 16.

Depending on the configurations, the fuselage 12 comprises a single opening 40 in vertical alignment with the storage line A14, or the various storage lines A14, of the hold 14. According to other configurations, the fuselage 12 comprises multiple openings 40, for example one for each storage line A14.

According to one configuration, the opening 40 is positioned at either the front end 14.1 or the rear end 14.2 of the hold 14. The opening 40 coincides with one of the stations 36 of the hold 14.

In addition to each opening 40, the fuselage 12 comprises at least one door 42 that is configured to adopt an open position in which it entirely frees up the opening 40, and a closed position in which it closes off the opening 40 and is flush with the rest of the fuselage 12.

According to one configuration, the fuselage 12 comprises two doors 42 that are articulated about pivot axes A42 which are parallel to the storage line A14, these doors being positioned outside the fuselage 12 when in the open position.

Of course, the invention is not limited to this configuration for the opening(s) 40 and the door(s) 42. Thus, at least one opening might be positioned on the side of the fuselage 12 in the extension of a storage line A14.

According to another feature of the invention, the hold 14 comprises at least one loading and unloading device comprising at least one carriage 44, at least one guiding system 46 configured to move the carriage along the storage line A14, at least one spreader 48 equipped with at least one system 50 for grasping a container, and at least one vertical movement system 52 that is configured to move the spreader 48 vertically with respect to the carriage 44. A single loading and unloading device can be used to load or unload all of the containers 16 stored in the hold 14.

According to one configuration, the guiding system 46 comprises at least one rail 54 that is secured to the upper wall 24 of the hold 14, along the storage line A14 which extends between a first end allowing the carriage 44 to grasp a container 16 located outside the fuselage 12 and a second end allowing the carriage 44 to be positioned in vertical alignment with the station 36 that is furthest from the opening 40.

According to one configuration, the aircraft 10 comprises a guiding system 46 for each storage line A14.

According to one embodiment, when the hold 14 comprises a single storage line A14, the guiding system 46 comprises a single rail 54 positioned equidistant from the right and left walls 26.1, 26.2 of the hold 14.

When the storage line A14 is straight, the rail 54 is straight.

When the opening 40 is positioned in the lower portion of the fuselage 12, the first end of each rail 54 of the guiding system 46 is positioned so as to allow the carriage 44 to be positioned in vertical alignment with the opening 40, approximately centered with respect to the opening 40.

When the opening 40 is positioned on the side of the fuselage 12, the guiding system 46 can be extended so as to be able to extend outside the fuselage 12 during loading and unloading, so as to allow the carriage 44 to be placed in vertical alignment with a container 16 positioned on the ground or on a dolly.

The carriage 44 is configured to move along the rail(s) 54 of the guiding system 46. According to one configuration, the carriage 44 comprises at least one motor 56 that allows it to move automatically and autonomously along the guiding system 46. At least one element among the carriage 44 and the guiding system 46 comprises a system for immobilizing the carriage 44 with respect to the rail 54.

According to one configuration, the carriage 44 and/or the guiding system 46 are configured to make it possible to separate the carriage 44 from the guiding system 46. According to one embodiment, one of the ends of the rail 54 is spaced apart from the corresponding end of the hold so as to be able to remove the carriage 44 from this end of the rail 54. As a variant, a section of the rail 54 is removable.

According to one embodiment, the vertical movement system 52 comprises at least one winch 58.1 that is secured to a first element among the carriage 44 and the spreader 48, and at least one cable 58.2 connecting the winch 58.1 to a second element, different from the first element, among the carriage 44 and the spreader 48. According to one configuration, the carriage 44 has a rectangular or square horizontal chassis, and the vertical movement system 52 comprises four winches 58.1 positioned at each angle of the chassis of the carriage 44 and each comprising a cable 58.2 connected to the spreader 48, these winches 58.1 being synchronized so that the spreader 48 retains its horizontal attitude during the vertical movements.

Of course, the invention is not restricted to this embodiment for the vertical movement system 52, which could comprise at least one scissor mechanism, for example.

In addition to the vertical movement system 52, the loading and unloading device may comprise a system for immobilizing the container 16 with respect to the carriage 44, configured to adopt a blocked state in which the container 16 is immobilized with respect to the carriage 44 and an unblocked state in which the container 16 can move with respect to the carriage 44. According to one configuration, this immobilizing system makes it possible to block and unblock each winch 58.1.

According to one embodiment, the spreader 48.1 has a substantially square or rectangular horizontal chassis that is configured to be positioned just above the upper face 30 of the container 16 which it is supporting.

The grasping system 50 is configured to adopt an activated state in which it secures the spreader 48 to a container 16, and a deactivated state in which the spreader 48 is separated from the container 16. According to one embodiment, the grasping system 50 comprises at least one hook 60 that is able to move between an attached position (corresponding to the activated state) in which it engages with a container 16, allowing the spreader 48 to support the container 16, and a detached position (corresponding to the deactivated state) in which it does not engage with the container 16. In addition, the grasping system 50 comprises, for each hook 60, a recess 62 that is configured to receive the hook 60 when it is in the attached position.

According to one configuration, the grasping system 50 comprises four hooks 60, 60′, two front hooks 60 configured to engage with the front recesses 62 positioned on the front face 34.1 of the container 16, and two rear hooks 60′ configured to engage with rear recesses 62′ positioned on the rear face 34.2 of the container 16. The front and rear recesses 62, 62′ are positioned close to the upper face 30, the front or rear recesses 62, 62′ being as close as possible to the right and left faces 32.1, 32.2.

Each front or rear hook 60, 60′ is mounted so as to be able to pivot about a pivot axis parallel to a transverse direction (perpendicular to the storage line A14 of the hold 14), the front looks 60 pivoting, about a same pivot axis, in a first direction to pass from the detached position to the attached position, the rear hooks 60′ pivoting, about a same pivot axis, in a second direction (counter to the first direction) to pass from the detached position to the attached position.

According to one configuration, the grasping system 50 operates autonomously and automatically, comprising at least one actuator to control the attached or detached position of the front and rear hooks 60, 60′.

Of course, the invention is not restricted to this embodiment for the grasping system 50. Other solutions can be envisaged in order to temporarily secure a container 16 to the spreader 48.

In one embodiment, each container 16 comprises a container identifier IDC, such as an RFID chip, a marking, a bar code or a QR code, for example.

In addition, the loading and unloading device comprises at least one piece of detection equipment among at least a reader configured to detect the station and/or container identifiers IDE and/or IDC, at least one control system that serves to determine an activated or deactivated state of the grasping system 50 and/or of the immobilizing system 38 of each station 36.

According to one embodiment, the loading and unloading device comprises a control system that is configured to control at least one element among the grasping system 50, the vertical movement system 52, the system for immobilizing the container 16 with respect to the carriage 44, the carriage 44 and the immobilizing systems 38 of the various stations 36.

According to one configuration, the loading or unloading device comprises a communication system by means of which the control system can be controlled remotely. Thus, using information provided by the detection equipment, an operator can remotely control the control system and control the grasping system 50, the vertical movement system 52, the carriage 44 and the immobilizing systems 38 of the various stations 36.

According to another configuration, the loading or unloading device comprises at least one computer program that autonomously or semi-autonomously controls the control system on the basis of information transmitted by the detection equipment.

Prior to loading, the containers 16 that are to be loaded are generally positioned on dollies 64 connected one after the other and towed by a tractor 66, as shown in FIG. 1.

Loading is carried out according to a loading plan which assigns each container 16 to a station 36.

A loading process comprises the following steps:

positioning a first container 16 in vertical alignment with the opening 40,

lowering the spreader 48 until it is positioned just above the container 16,

activating the grasping system 50 to secure the container 16 to the spreader 48, as shown in FIG. 6,

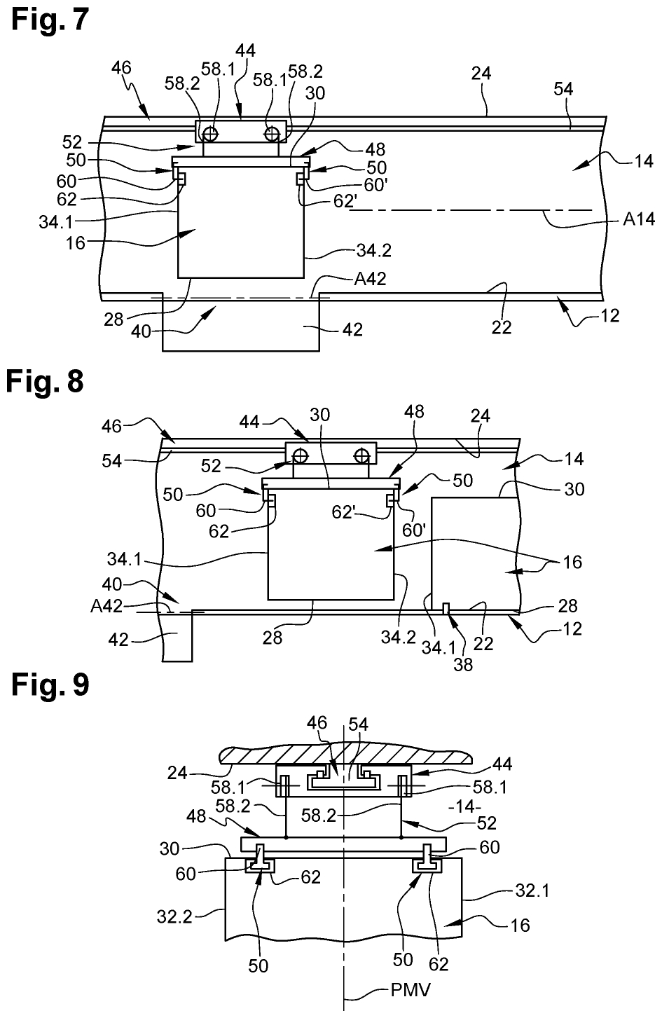

moving the spreader 48 and the container 16 vertically upwards until the container 16 is positioned in the hold 14, as shown in FIG. 7,

activating the system for immobilizing the container 16 with respect to the carriage 44,

moving the carriage 44 horizontally, along the storage line A14, as shown in FIG. 8, until it is positioned in vertical alignment with the station 36 assigned to the container 16 in the loading plan,

lowering the spreader 48 and the container 16 until the container 16 rests on the lower wall 22 of the hold,

activating the immobilizing system 38 in order to fasten the container 16 to the hold 14,

deactivating the grasping system 50 in order to separate the container 16 from the spreader 48.

From that point, the carriage 44 and the spreader 48 are moved so as to reach another container which is to be loaded and which has been positioned in vertical alignment with the opening 40.

The last container which is loaded is positioned in the hold 14, in vertical alignment with the opening 40, and remains secured to the spreader 48. The doors 42 of the hold 14 are then closed.

For unloading, the containers 16 are removed from the hold 14 one after the other, each one being secured to the spreader 48, separated from the hold 14, lifted, moved to be in vertical alignment with the opening 40, lowered so as to rest on a dolly 64, then immobilized with respect to the dolly 64 and finally separated from the spreader 48.

The loading and unloading device according to the invention makes it possible to dispense with airport equipment for transferring the containers 16 between the ground and the hold.

Finally, it means that the operators do not have to push the containers, and might make it possible to automate the operations of loading and unloading the containers.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft comprising:
a fuselage,
at least one hold positioned in the fuselage and configured to store containers along at least one storage line, and
at least one opening configured to provide a passage between the hold and the exterior of the fuselage,
wherein the opening is positioned in vertical alignment with the storage line or in line with the storage line, and
wherein the hold comprises
at least one loading and unloading device comprising at least one carriage,
at least one guiding system configured to move the carriage along the storage line,
at least one spreader equipped with at least one grasping system and at least one vertical movement system that is configured to move the spreader vertically with respect to the carriage, the grasping system being configured to adopt an activated state in which the grasping system secures the spreader to a container and a deactivated state in which the spreader is separated from the container, and
a lower wall on which the containers are positioned,
multiple stations positioned along the storage line, one for each container, and
at least one immobilizing system for each station, this being configured to adopt an activated state in which the immobilizing system immobilizes a container with respect to the hold and a deactivated state in which the immobilizing system allows the container to move.

2. The aircraft as claimed in claim 1, wherein the opening is positioned in the lower portion of the fuselage.

3. The aircraft as claimed in claim 1,
wherein the hold comprises an upper wall, and
wherein the guiding system comprises at least one rail that is secured to the upper wall of the hold, along the storage line and extending between a first end allowing the carriage to grasp a container located outside the fuselage and a second end allowing the carriage to be positioned in vertical alignment with a station, for a container, that is furthest from the opening.

4. The aircraft as claimed in claim 1, wherein the vertical movement system comprises at least one winch that is secured to a first element among the carriage and the spreader, and at least one cable connecting the winch to a second element, different from the first element, among the carriage and the spreader.

5. The aircraft as claimed in claim 1, wherein the grasping system comprises at least one hook that is able to move between an attached position in which it engages with a container, allowing the spreader to support the container, and a detached position in which the hook does not engage with the container, the grasping system comprising, for each hook, a recess in the container that is configured to receive the hook when it is in the attached position.

6. The aircraft as claimed in claim 5, wherein the grasping system comprises two first hooks that are configured to engage with first recesses located on a first face of the container and second hooks that are configured to engage with second recesses located on a second face, opposite the first face, of the container.

7. The aircraft as claimed in claim 1,
wherein at least one of each container or each station comprises a container identifier or a station identifier, and
wherein the loading and unloading device comprises at least one piece of detection equipment among at least a reader configured to detect the station or container identifiers and at least one control system that serves to determine an activated or deactivated state of at least one of the grasping system or of the immobilizing system of each station.

8. The aircraft as claimed in claim 1, wherein the loading and unloading device comprises a control system that is configured to control at least one element among the grasping system, the vertical movement system, the carriage and the immobilizing systems of the various stations.

9. The aircraft as claimed in claim 8, wherein the loading or unloading device comprises at least one of a communication system that is configured to remotely control the control system or at least one computer program that is configured to control the control system.
